(19) United States
(12) Patent Application Publication
(10) Pub. No.: US 2010/0087237 A1
(43) Pub. Date: Apr. 8, 2010

(54) SYSTEM FOR USING ELECTRONIC DEVICE AND THE ELECTRONIC DEVICE

(75) Inventor: Reinaldo Oliveira Normand, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: TEC TOY S.A., Sao Paulo (BR)

(21) Appl. No.: 12/295,272

(22) PCT Filed: Dec. 14, 2006
(86) PCT No.: PCT/BR2006/000279

§ 371 Date: Dec. 22, 2009

(30) Foreign Application Priority Data
Apr. 12, 2006 (BR) PI0601492-5

(51) Int. Cl. A63F 9/24; A63F 13/00

(52) U.S. Cl. 463/1; 463/25; 463/32; 463/36; 463/43; 463/42

(57) ABSTRACT

The present invention refers to a system for using the electronic device comprising a billing server, a data storage server and a delivery platform (hardware and software) for delivering games, applications and value added services (Internet navigation, news, virtual communities, movies, music, etc) upon the requests of the electronic device user. The electronic device uses the architecture of a mobile handset for running the games and services. The purchase and downloading of games may be carried out with the same technology used by mobile carriers, but not only necessarily through them. Other wireless and wired transmission mechanisms and methods may be used.

The present invention refers to a video game system using the architecture (software and hardware) of a mobile handset for running games and value added services in an external screen such as a TV or a computer monitor. This device must be connected to an external power supply (alternating current) to function.

### DESCRIPTION OF THE PRIOR ART

The video game is an electronic equipment dedicated to run specific programs (games) for entertainment purposes. Such programs are saved in internal and/or external storage devices (cartridges, non-volatile memory devices, hard drives, optical disks), in which it is possible to interact by commands given by means of an input device, usually called Joypad.

The games information is processed inside the device by specialized computer microprocessors, and made available to the players with the aid of a graphic user interface (UI). The images are shown in any video devices, such as a TV, CRT or LCD monitors, etc.

The traditional video game business model is based on the purchase of the specific program (game) from a retail store in a tangible media such as a CD, DVD, cartridge memory card or other technology.

That is, the user has the storage device on hands that is physically connected to the video game before data is transferred for subsequent execution. In some modern video games, the user may digitally download some programs and games from the Internet or specific channels through wireless (Wi-Fi, satellite, radio) or wired means (cable, landline, USB, etc). As of December 2006, no games for dedicated video game systems are sold wirelessly using the technologies and standards adopted by mobile carriers.

### OBJECTS AND ADVANTAGES OF THE INVENTION

The objects of the present invention are reached by the electronic device and a system for using the electronic device comprising a billing server, a data storage server and a delivery platform (hardware and software) for delivering games, applications and value added services (Internet navigation, news, virtual communities, movies, music, etc) upon the requests of the electronic device user. The electronic device uses the architecture of a mobile handset for running the games and services. The purchase and downloading of games may be carried out with the same technology used by mobile carriers, but not only necessarily through them. Other wireless and wired transmission mechanisms and methods may be used.

These and other features, objects and advantages will be apparent in the following detailed description of the best mode, when considered together with the attached drawings, and the claims, all of which are incorporated as part of the invention disclosure.

### BRIEF DESCRIPTION OF THE DRAWINGS

In the drawings, the reference numbers refer to parts along with the several views, in which:

FIG. 1 is a schematic view of a first embodiment of the system object of the present invention, and;

FIG. 2 is a block diagram of the system object of the present invention.

### DETAILED DESCRIPTION OF THE DRAWINGS

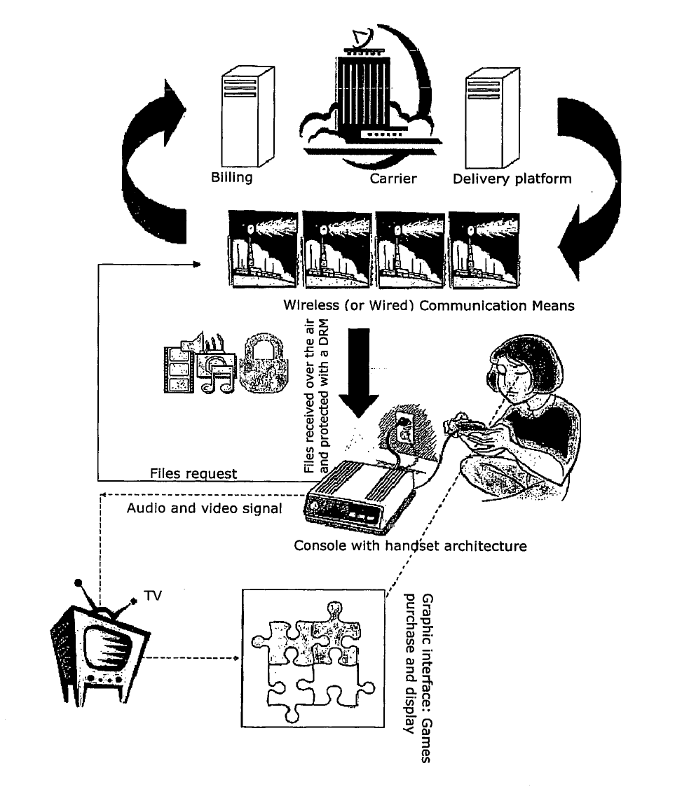

As it can be seen from FIG. 1, a system object of the present invention comprises of a billing server, a data storage server, a games and services delivery platform (hardware and software) and bidirectional means of communication to answer the requests of the user of the electronic device provided with the architecture of a mobile handset.

The electronic device comprises main units as follows:
One (or more) Central Processing Units (CPU)
Read-only non-volatile memory.
Writing and reading non-volatile memory.
Volatile memory with speed adequate for the CPUs performance.
Glue logic.
Interface for external devices.
Power supply.

Except for part of the interface for external devices and the power supply, the type of configuration described above is actually implemented with digital circuits, where the low voltage C-MOS technology has prevailed in terms of cost, integration and speed.

One option that makes the reduction of costs feasible in large-scale production is the integration of the blocks above in one or a few components. The term used herein is ASIC (Application Specific Integrated Circuit).

It must be reminded that the components described herein may be replaced by any other, since they are functional and are within the scope of the present invention.

The main chip is the component responsible for the functional logic of the invention. Among several other minor functions, it is responsible for the:
Simulation of the Game Intelligence.
Video generation.
Sound processing.
Navigation through the games' menus.
Navigation in the Internet.
Processing of communication and storage protocols.
Processing of the copyright protection software (DRM) and consequent blockage of an occasional illegal execution.

Additionally, the device object of the present invention comprises a dedicated chip, that is, an additional video chip for manipulating 3D graphs. This is necessary to help the main chip during the high-complexity 3D applications manipulation task, such as the electronic games.

Said chip works together with other hardware and software installed in the equipment. In some cases, the dedicated chip may be part of the processor or main “chipset” structure.

The device further comprises writing and reading non-volatile memory. Rigorously according to the definition, the read-only memory (ROM) could never have its contents changed. In practice, we can find devices that allow updating of their data under specific conditions.

Due to its non-volatile characteristic in case of power failure, this is a especially interesting device for storing user-changeable system configurations, and specifically, in the present invention, as a storage unit for the transferred games.

Other applications that could be stored include the graphic interface and other software required for the device to work properly (Operating System such as Symbian, Windows, Linux, etc and APIs compatible with games such as JAVA, Brew, EGE, Open GL, Direct X, etc).

The physical location of the specific programs (games), and audio, photo and video files related to the present invention may basically have two options. The first option is within the device so that the user has no access to the component, or, the second option, as a removable device that could be used in other applications or simply for precaution purposes. In this second option, it becomes possible to purchase a new game upon every new memory device substitution. This operation is very similar to that carried out by computer users when files are transferred from or to diskettes, discs or pen drives.

A volatile memory with adequate speed for the performance of common CPUs, known as RAM, is further provided. Some CPUs are already provided with a volatile memory; however, in order to better process the applications, a high-speed memory with writing and reading characteristics is required.

The RAM memories are an essential item in the device. In said memories, all variables, data and controls processed by the CPU are temporarily stored.

The device comprises a “glue logic”, that is, a complementary digital circuit to allow the interconnection of the CPUs among each other, among the memory devices and any other peripherals. Each type of system requires a different solution for this logic, depending on the criteria adopted by the designer. Some commercial CPUs integrate, in their silicon wafer, functions that allow, in some cases, to develop complete systems with a minimum “glue logic”.

Interface For External Devices

In a number of microprocessed projects, it is necessary to convert the digital signals circulating through the CPUs and memories, into analogical signals. The opposite path is also true. Common examples are temperature controls and computer network lines.

Within the scope of the present invention, this interface is responsible for connecting the device to the remote content provider. Regardless whether the physical transmission is through wired or wireless means, it is necessary to perform the digital-into-analogical conversion together with a modulation. This is why the technical term MODEM (Modulator/Demodulator) is very generically employed.

For example, the MODEM can be connected to a dial-up line (this is the most frequently heard), but can be also connected to a coaxial cable of private TV networks, access the radio frequency ranges, etc.

If the modem needs to transit data through wireless networks, a radio transmitter is also included that could use technologies and protocols, such as AMPS, CDMA, GSM, i-Den, D-AMPS, CDMA-One, PDC, CSD, GPRS, HSCSD, WiDEN, CDMA 200 1xRTT, EDGE, W-CDMA (UMTS or FOMA), CDMA 2000 1xEV, TD-SCDMA, HSDPA, HSUPA and others.

Moreover, the interface for external devices does not necessarily have to be analogical. Several external devices, such as printers, digital cameras, USB keys and others may be further accessed in the digital domain.

Several of these interfaces are standardized in the marketplace to mention some examples: USB, IEEE 1394, serial, parallel, SD-Card, MMC, Memory Stick, infrared, bluetooth, Wi-Fi, Wi-Max, etc. The purpose is to provide data exchange with the main device and peripherals. For example, it is possible to transfer a game or saved file to a USB pen drive from a non-volatile memory of the device. It is also possible to run the software contained in the connected device itself (memory cards), through cables (joypad, camera) or wirelessly (computer, palmtop, handset).

A very peculiar interface in the present invention is the interconnection with the famous Joypad, the input device that allows the user to interact with the virtual game environment.

One of the most important interfaces characterizing the video game device concept is the video out connection which sends the internally processed images to external equipment, such as TVs, computer monitors and projectors (screens that do not belong to the device physical structure); and the audio out.

The video game device, as per its definition, should have an external chassis to pool the components in a box that may be placed close to display devices and external power outlets.

The input device used in the electronic device, object of the present invention, is a Joypad to send interactive commands to the video game device and to interact with the game.

The system comprises software to manage the device hardware, such as a boot loader (a small set of instructions to start the operating system). Additionally, a ROM memory or external storage sources is provided in the main chipset. A solution of the present invention is to make a proprietary “boot loader” to reduce the risk of piracy.

The system further uses a software that manages all the hardware of a machine (operating system), including the memory, processors and input and output devices. The existing open systems that may be licensed and used in our device include: Brew (AMSS), Symbian, Windows Mobile, Linux, Mobilinux, Palm OS, etc. Depending on the “chipset” we use, the system may be embedded in it and be a proprietary solution of the manufacturer. A proprietary operating system may be still provided for the device.

So that the “mobile video game” can be compatible with the existing “mobile” games, the system uses APIs and standard interfaces that work with the main operating systems and “chips”. The main ones are the J2ME (Java Micro Edition), Brew (Binary Runtime Environment for Wireless) and OpenGL (Open Graphics Library). These APIs allow total compatibility with the existing software base (including mobile games) for handsets, regardless of the adopted hardware. In order to avoid piracy, a proprietary version of such APIs can be provided.

Other important APIs and interfaces that may be used include UiOne, EGE, MMAP, JSRs, Mascot Capsule, DoJa, Flash LE, Direct X Mobile, etc.

Other important software in the device is the DRM (Digital Rights Management), which protects from piracy the digitally purchased contents. The most commonly known in the market include WMDRM, OMA, Steam, CPRM, OpenMG, Fairplay, etc. To be effective, the DRM must be installed in the device, files and the delivery platform.

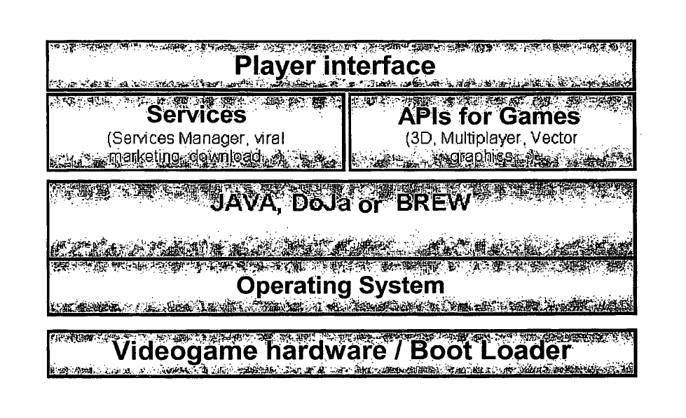

The software and hardware layers scheme used can be seen in FIG. 2.

The video game may run games in J2ME, DoJa, Brew, EGE, Symbian, Pocket PC, Smartphone and other formats used in handsets that can be possibly created.

Applications available for handsets, such as videos, music, SMS, ringtones, wallpapers and chats may also be run provided that they are compatible with the abovementioned technologies.

The device could include some licensed games in a non-volatile memory. Said games will be embedded in the hardware and sold as part of the retail video game. They can be played free of charge.

One of the objects of the present invention is that the programs can be purchased only and exclusively by data download. No distribution of games, services and applications through physical media will be made.

The games would be stored in remote content servers and not in the device itself. These servers could be accessed through wired or wireless communication means. The consumer could access the remote server through the video game graphic user interface, select the desired game or application, purchase it, download it and run it whenever he/she wishes.

Another option is to access the remote content servers by means of a personal computer installed in the user's home, retailers, post offices or cybercafes. In this case, the software would be selected, paid and downloaded through the Internet to the PC hard disk, and then copied by the user in a memory card or pen drive. The DRM software would prevent the copy to other computers and/or devices. To run the games downloaded into the memory card or pen drive, the user would insert the physical storage means in the video game and it would automatically copy the game to the non-volatile memory. Next, just launch the game and have fun.

In the envisioned business model, the retailer would not sell physical means (such as cartridges and DVDs) containing the games. However, the games could be digitally downloaded to physical means, such as pen drives, hard disks or memory cards. It will not be possible to buy games stored in physical means, but games could be electronically downloaded to physical means. The purpose is to reduce the distribution costs and retailers' margins, fight piracy and simplify the buying process for the user.

The business model corresponding to the game purchase would be embedded in the selection and downloading processes. In other words, a business operation related to the purchase of the game copyright would be accomplished during these processes. Game renting options could be included.

The physical means through which the data traffic will occur is not specific right now, but should be something that characterizes a distance transfer. Some possible examples include:

Wireless:
Radio frequency band and protocols used by the mobile carriers.
Future implementation of the Mobile Digital TV standard.
Radio frequency band and protocols used by Internet servers.

Wired:
Coaxial or optical cables that are able to serve several protocols and signals simultaneously, such as: Internet, Digital TV and analogical TV.
Dial-up line or DSL (landline). FSK or any other modulation adequate to the means.

Note that we described a physical situation at the device installation location, usually the client home. If the physical means change during the route, this is not a detail to be approached in this descriptive report. For example, if the original signal travels by a dial-up line and at a certain point of the route it becomes a wireless signal.

The final product may use one or a combination of the options above, including several models of products with different options. The present invention also provides the possibility that the remote access is aided by another type of product connected to the device. Typical examples are personal computers and handsets.

The differences between the existing video game business and the present invention lies in the evolution of the games distribution mechanisms (exclusively through electronic and digital means), the use of the existing technologies for handsets as the primary architecture of the video game console bound to a business model specific for developing countries with games and the console itself at low prices.

In order to purchase more games, the user should connect to a Virtual Store or Internet site by pressing a button in the joypad and launching a navigator that, by using the Internet infrastructure, could access the available catalog of applications.

To proceed with the purchase, like in a mobile phone or website environment, the user should choose the desired game by navigating in the store's options menu by the manipulation of the video game joypad. By clicking ‘buy’, the user sends an authorization to the “billing” server that checks the user's credits and authorizes or denies the purchase. The delivery platform is then activated and the game is sent to the device's non-volatile memory through appropriate means of communication (wireless or wired). The process is done with the aid of a DRM software.

If the device uses mobile technology standards or protocols, it can be subsidized by mobile carriers as part of their current business model. In this case, the virtual store credits could be loaded using carriers' prepaid cards purchased at points of sale. Then, the user would dial a special number provided by the carrier and would insert the credits in his/her account. In the next purchase, the credits would be billed upon the download of any application from the virtual store. Other payment methods used would be mobile payment, direct debit, credit card and bank payment slip.

A consumer service (via mobile phone) would be made available in order to generate voice traffic to the carrier, the virtual store supplier being entitled to a “revenue-share” on the total amount.

It will be obviously seen that while the above was described as an illustrative example of the present invention, all other modifications and variations of the present invention, as it would be apparent to those skilled in the art, are considered within the wide scope and ambit of the present invention as claimed in the attached claims.

1. “SYSTEM FOR USING ELECTRONIC DEVICE” characterized in that it comprises a billing server, a data storage server and a delivery platform (hardware and software) for delivering games, applications and value added services (Internet navigation, news, virtual communities, movies, music, etc) upon the requests of the electronic device user through electronic means of communication (wired or wireless). The electronic device uses the architecture of a mobile handset for running the games and services.

2. “SYSTEM FOR USING ELECTRONIC DEVICE” as claimed in claim 1, characterized in that a program is purchased only and exclusively by means of electronic data download and, in most cases, without the distribution of games through physical media (optical disks, memory cards, etc).

3. “SYSTEM FOR USING ELECTRONIC DEVICE” as claimed in claim 2, characterized in that it uses the infrastructure of the mobile carriers for purchasing and downloading the games.

4. “SYSTEM FOR USING ELECTRONIC DEVICE” as claimed in claim 3, characterized in that the device comprises:
one or more central processing units (CPU);
read-only non-volatile memory;
writing and reading non-volatile memory;
volatile memory with speed adequate for the CPUs performance;
glue logic; and
interfaces for external devices.

5. “SYSTEM FOR USING ELECTRONIC DEVICE” as claimed in claim 4, characterized in that the device comprises a main chip, said chip being the main component responsible for the device functional logic.

6. “SYSTEM FOR USING ELECTRONIC DEVICE” as claimed in claim 5, characterized in that the device comprises an additional video chip for manipulating 3D graphs that is necessary to help the main chip during the high-complexity 3D applications manipulation task.

7. “SYSTEM FOR USING ELECTRONIC DEVICE” as claimed in claim 6, characterized in that the video game device comprises video out and audio out for external devices.

8. “SYSTEM FOR USING ELECTRONIC DEVICE” as claimed in claim 7, characterized in that the device comprises an input device (Joypad).

9. “ELECTRONIC DEVICE”, characterized in that it is as used in the system defined by the previous claims.
